(19) United States
(12) Patent Application Publication
(10) Pub. No.: US 2021/0115907 A1
(43) Pub. Date: Apr. 22, 2021

(54) Asymmetrical impulse drive

(71) Applicant: Steven Michael Hampton, Avon, IL (US)

(72) Inventor: Steven Michael Hampton, Avon, IL (US)

(21) Appl. No.: 16/602,494

(22) Filed: Oct. 18, 2019

(51) Int. Cl. F03G 3/00

(52) U.S. Cl. CPC F03G 3/00; B64G 1/409

(57) ABSTRACT

Electric In-Space propulsion uses no fuel. Thrust is generated as impulses where in space, momentum is additive. Rotary motion is converted into bi-linear oscillation of a carriage then its momentum rectified: The carriage is shifted forward during low inertia, so momentum used to oscillate the carriage forward is conserved to be used later in the cycle. Reverse carriage oscillations are deflected. This creates only a pulsed demand on the electric power supply—thus too fulfilling the law of Conservation of Energy: Newton's third law of motion is upheld because action and reaction are not simultaneous events, so in this engine, the inertial delay occurs at post carriage shift during part of the rotors' orbit—when centrifugal force emerges: The centripetal force of the rotors are cyclically nullified by the shift resulting in surges of centrifugal force.

### BACKGROUND OF THE INVENTION

### 1. Field of the Invention

This invention relates to self-contained apparatus for converting rotary motion into linear motion, and more particularly to devices utilizing unbalanced centrifugal forces in such a manner to result in moving the device along a linear path.

### 2. Description of the Prior Art

Numerous attempts have been made to propel a drive apparatus and attached vehicle along a linear path with the apparatus using unbalanced centrifugal forces generated by gyratory action within the apparatus. However, the known devices are incapable of exerting a substantial and significant linear force to be useful as a drive apparatus. The interrelationship of their component parts produces forces which tend to cancel out each other with little or no resultant linear force being exerted. Also, the prior art devices often are complicated and have excessive internal friction which further reduces their efficiency. The prior art also does not have a substantial axial displacement which is tantamount to producing thrust in rotary to linear systems, nor have a means for negating back forces. Neither can such prior art with the greater axial displacement cycle at a high enough rate to overcome the apparatus's own inertia and propel itself with a meaningful load in a linear path.

Typical of the prior art approaches to the conversion of rotary motion into linear motion are the following patents:

| Patent No. | Date of Issue | Inventor |
|---|---|---|
| 2,886,976 | May 19, 1959 | Dean |
| 3,182,517 | May 11, 1965 | Dean |
| 3,238,714 | Mar. 8, 1966 | G. O. Schur |
| 3,653,269 | Apr. 4, 1972 | Foster |
| 3,979,961 | Sep. 14, 1976 | Schnur |
| 4,050,317 | Sep. 27, 1977 | Brandt |
| 4,238,968 | Dec. 16, 1980 | Cook |
| 4,744,259 | May 17, 1988 | Peterson |
| 4,770,063 | Sep. 13, 1988 | Mundo |
| 5,024,112 | Jun. 18, 1991 | Kidd |
| 5,090,260 | Feb. 25, 1992 | Delroy |
| 5,156,058 | Oct. 20, 1992 | Bristow, Jr. |
| 5,831,354 | Mar. 11, 1998 | T. J. Stopplecamp |
| 7,008,276 | Mar. 7, 2006 | V. R. Laul |

The above listed patents are believed to be relevant to the present invention because they were adduced by a prior art search made by an independent searcher and the inventor.

### SUMMARY OF THE INVENTION

The method of converting rotary motion into linear motion of the present invention involves orbiting a set of two eccentrics in opposite directions on a plane where the force of their masses add on two sides every cycle to produce a bi-directional impulse on said plane of oscillation. Another set of counter eccentrics may be arranged along the same oscillatory plane of the previous set of eccentrics but set up to 180 degrees out of phase with the first. Any number of such sets of eccentrics may be used along the plane of oscillation at varying degrees of separation. A means is also provided to shift, clutch, and release the axis of the eccentrics at a precise time in their cycle to impel the apparatus in the desired direction.

The linear force from this reciprocating impulse drive may be used to propel any object attached to the mainframe of the present invention without requiring loss of mass into the surrounding environment.

The self-contained linear drive of the present invention, however, requires only the amount of energy necessary to spin the mass units and to shift their axis with none of the energy being expended or wasted by ejecting mass from the linear space drive.

The rotary to linear drive of the present invention is useful for propelling other vehicles such as boats and automobiles. Such a watercraft would need only hull contact with the water which can be streamlined to the most efficient shape for traveling on the surface or below the water. Because the direction of force can be changed within the vehicle, no rudders or other external apparatus may be required.

As a closed In-space drive system for satellite, spacesuit, towing and spacecraft propulsion the linear drive means of the present invention does not require a reserve of propellant to drive said vehicle and may run on solar cell panel and rechargeable batteries, a remotely towed nuclear generator or other energy sources.

The described uses of the present invention are only illustrative and many other uses and advantages of the present invention may be found.

The preferred invention converts rotary motion into linear motion at a frequency high enough to overcome the apparatus's inertia and propel said apparatus with a load. The present invention could drive a satellite already in orbit or beyond and propel a spacecraft between the planets with an estimated twenty-times the efficiency of conventional propulsion systems without losing mass.

The preferred invention provides a flat carriage tray or plate which holds a set of eccentric rotors mounted directly on inter-meshing gears that counter-rotate on said carriage plate. The plate must be constructed of rigid lightweight material and the rotors should be as heavy as practical. The said carriage plate is suspended on compression spring-loaded rods on a common mainframe. When the rotors are activated the said carriage will oscillate equally to and fro with equal force and distance.

During operation, when the counter-spinning rotors are aligned with both axis across the carriage, with the rotors either to the outsides or towards the center of said carriage perpendicular to the plane of oscillation, will cancel carriage momentum and at this time the carriage can be easily moved or shifted by an external force. When the rotors are to the front or rear ends of said carriage, their momentum adds and they swing the carriage in that direction—but there is a 45-degree delay in that carriage motion. This accounts for a “phased” appearance of the rotors while spinning wherein they take on the pattern of out-toeing “baby shoes”.

In the preferred invention, the carriage suspension system is composed of a front set of stiff springs and a rear set of lighter-duty springs that allows for limited dampening of the carriage once it is released by the shifter(s) thus producing an asymmetrical reaction to the mainframe. Additional energy absorbing material at the back of the rear springs further dampens the negative phase so as to accentuate overall positive thrust.

The said apparatus's thrust is determined by the rotors mass and velocity which can be finely controlled by varying the voltage to the rotors drive motor(s). A means to shift the carriage towards the positive direction in the plane of oscillation is provided. When the apparatus's shifter(s) is engaged, the carriage is advanced 45 degrees ahead of its normal oscillatory cycle and held in place for 90 degrees so that the centrifugal force normally used to propel the carriage forward may be used to propel the mainframe forward. The shifter(s) then releases the carriage once the rotors have passed apogee by precisely 45 degrees so that a new cycle may be established. The negative phase of said oscillation is dampened to affect a stronger positive bias to the system. The 360-degree rotary motion of the rotors are converted into 180-degree bilateral motion of the carriage where centrifugal forces are additive, which is then precessed to release impulses for thrust: The motion of the carriage plate is rectified from a sinusoidal motion to an unbalanced impulse.

The present energy-efficient invention represents an asymmetrical oscillator with three separate inertial frames in motion every cycle. Momentum is conserved because the spinning rotors' cycle within their swinging carriage cycle creates two inertial frames that when shifted into positive phase when said carriage has low inertia, forces the carriage to gain time during the shift so the rotors can provide momentum to the carriage: Momentum used to oscillate the carriage in the forward direction is conserved to be used later in the cycle. This creates a pulsed phenomenon upon the outer inertial frame, or mainframe, generated from the other two inertial frames of the rotor/carriage complex resulting in cyclic demands on the power supply—thus also fulfilling the law of Conservation of Energy. Newton's third law of motion is upheld because action and reaction are not simultaneous events, and in this apparatus, the inertial delay is between the carriage shift and the rotors during 90 degrees of their orbit when centrifugal force can manifest: The centripetal force of the rotors are momentarily interrupted resulting in a release of centrifugal force.

The present invention requires minimal lubrication by use of sealed motor bearings, thermoplastic or other special bushings, linear bushing housings, lightweight and low-friction gears and use of a dry lubricant for low maintenance.

It is therefore a principle object of the present invention to provide a method and apparatus for converting rotary motion into linear motion in a self-contained unit.

Another object of the present invention is to provide an apparatus for converting rotary motion into linear motion in a self-contained unit capable of propelling an attached vehicle in a desired straight-line direction which can be varied from time to time as desired.

A further object of the present invention is to provide an apparatus of the character described which is open, compact and sturdy with a minimum of moving parts subject to friction and wear thus requiring a minimum of maintenance and ease of maintenance and assembly.

A still further object of the present invention is to provide an apparatus of the character described which is relatively inexpensive and requires a minimum of machining.

Other objects and features of advantage will become apparent as the specification progresses, and from the claims.

### BRIEF DESCRIPTION OF THE DRAWINGS

The invention is illustrated diagrammatically in the accompanying drawings by way of example. The diagrams illustrate only the principle of the invention and one mode of applying said principle. It is however to be understood that the purely diagrammatic showing does not offer a survey of possible constructions and a departure from the constructional features diagrammatically illustrated does not necessarily imply a departure from the principle of the invention.

In the drawings:

FIG. 1 is an overview diagram illustrating the rotor side and depicting nearly all the major components comprising the invention.

FIG. 2 is an overview diagram looking at the back of the invention illustrating the timing cam side with the mounted motor on the carriage plate and glide rod dampeners.

FIG. 3 is a cut-a-way view to the rotor gear complex with its linear bushing housings, bearings, analog and optic timing cams.

FIG. 4 is an enlarged view of the electrical and timing circuitry at the back center of the carriage detailing the emergency back-up analog cam system in case of an electromagnetic pulse (EMP) attack upon the apparatus.

FIG. 5 shows the adjustable linkage system for the carriage-to-solenoid plunger so that stroke-length may be fine-tuned for optimal thrust.

FIG. 6 is an electrical block diagram and schematic of the invention.

FIG. 7 is a detail of the negative phase dampener.

FIG. 8 is an accelerometer test chart.

While only the preferred form of the invention is illustrated in the drawings, it will be apparent that various modifications could be made without departing from the scope of the claims.

### DESCRIPTION OF THE PREFERRED EMBODIMENTS

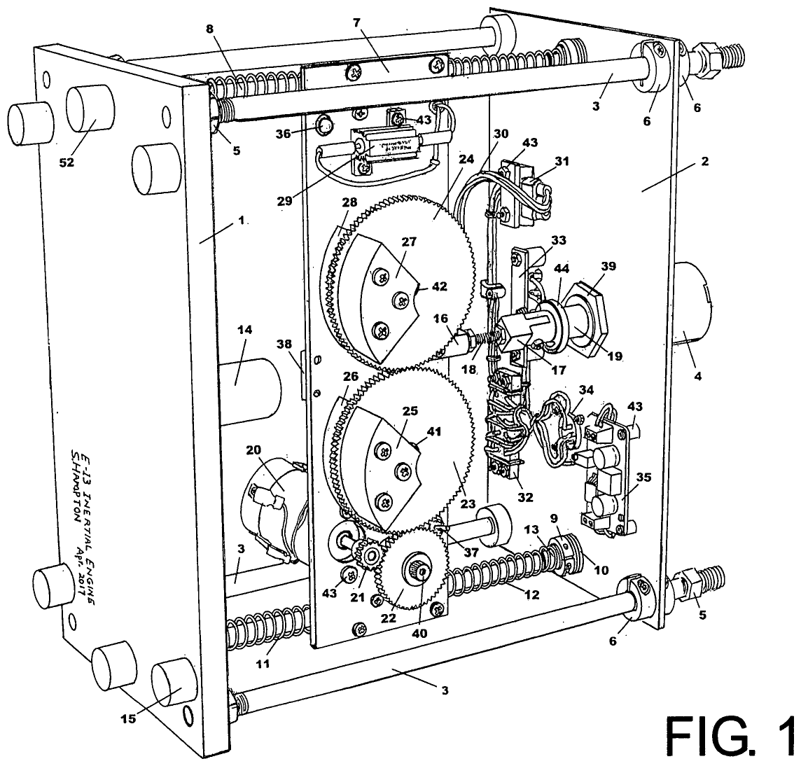

In FIG. 1, the mainframe assembly comprises of a base plate 1 at left joined to a thrust plate 2 far right by a plurality of mainframe support stanchion rods, straps, angled rails, or plates 3. The mainframe stanchions 3 may also hold an additional cover plate above the thrust plate 2 to offer protection to the solenoid 4 coil and its housing. Solenoid 4 may also be heat-sinked to the thrust plate with heat sink compound or radial heat sink fins. In the illustrated example, the mainframe stanchions 3 that join base plate 1 and the thrust plate 2 may employ fastening devices such as threaded nuts 5, rod clamps 6 or other means to secure the assembly. The use of stanchions 3 give the apparatus strength, durability and allows for easy stroke distance adjustments and disassembly for maintenance or repair.

The carriage 7 (at center) is suspended by a plurality of glide rods 8 that are secured to the thrust plate 2 by means of rod clamps 9 (far lower right) or other such fasteners, and stroke length may be adjusted with washers or spacers 10.

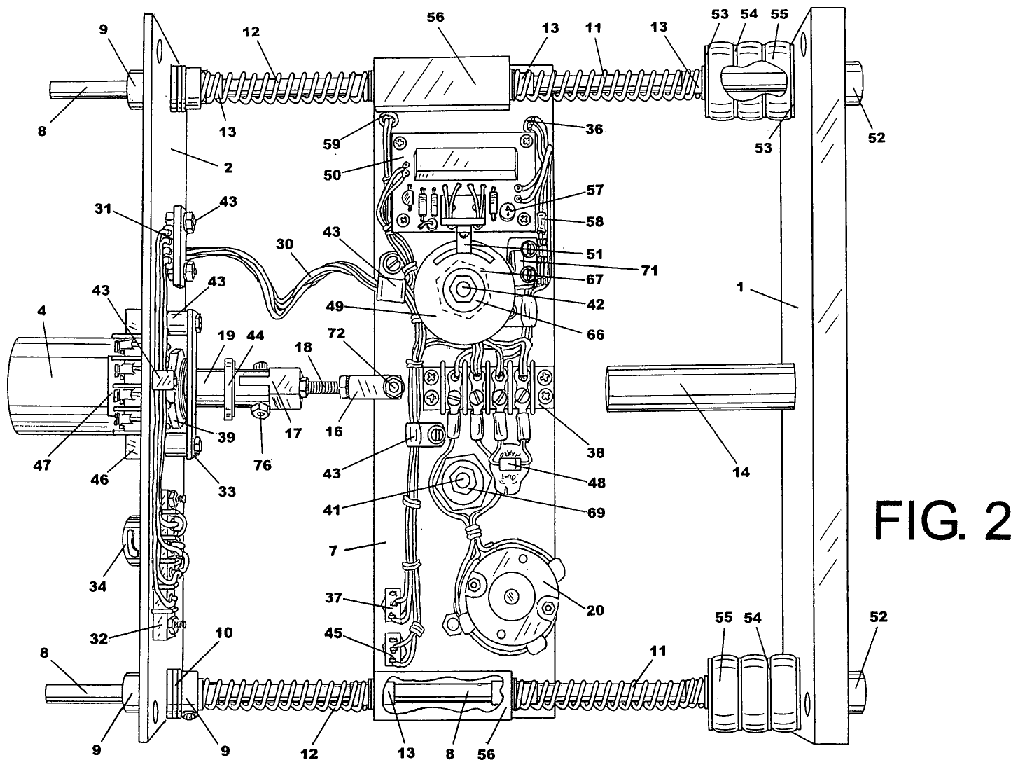

The glide rods 8 are surrounded by two different compression springs pairs: the back springs 11 and the front springs 12. Said springs are mounted on bushings 13 (far lower right) on both ends each to minimize spring contact with the glide rods 8 and to reduce impact and wear on glide rods and glide rod clamps 9. Said bushings may be made of self-lubricating thermoplastic or other material. This arrangement allows for the springs to separate from the linear bushing housings (56, FIG. 2) and thrust plate 2 seats so as to ride freely on the glide rods 8 when the carriage 7 is oscillating at high frequencies for greater thrust. The back springs 11 has a spring-rate that is less than the spring-rate of the front springs 12. A soft shock-absorbing slug 14 (center left) provides support and prevents damage to the back springs 11 should the carriage plate 7 swing too far back or when the apparatus is standing vertically against gravity on the base plate pads 15.

A coupling clevis 16 (at center) attaches to the carriage plate 7 that joins the solenoid plunger adapter 17 by means of an adjustable linkage 18 to the solenoid plunger 19 (far right center). Adapter 17 may be slightly loose-fitting to compensate for variations of side-play between the carriage plate 7 and its glide rods 8. Parts 16, 17 and 18 may also be manufactured as one part.

A motor 20 (lower left) drives a pinion 21 that steps up torque to idler gear 22 that also drives and increases torque to the first rotor gear 23 that inter-meshes and counter-rotates the second rotor gear 24 (both center of drawing). Motor 20 can be mounted anywhere on the carriage 7. Idler gear 22 may be made of a dis-similar material such as Acetal, nylon or other material, than pinion 21 and rotor gears 23 and 24 to help reduce gear noise and wear.

The rotor complex consists of a pair of heavy weights that are divided into two or more parts that sandwich the rotor gears 23 and 24. Rotor 25 having the larger mass, is mounted on the front face of gear 23 and is secured to its mating rotor 26 through the rotor gear 23 and mounted on the back face of said rotor gear 23. In the same fashion, rotor 27 having the larger mass, is mounted on the front face of gear 24 and is secured to its mating rotor 28 through the rotor gear 24 and mounted on the back face of said rotor gear 24.

Optional current limit resistor 29 (upper center) on carriage 7 is electrically in series with motor 20 to fine-tune rotor speed or otherwise control said motor speed and may be heat-sinked onto carriage 7. Umbilical 30 is an insulated wire bundle that is coiled to resist wear from flexing as it feeds power to the motor 20 on the carriage 7, and a switched signal from the carriage 7 back up to the solenoid 4 shifter(s). Umbilical 30 may be made of stranded wire for long life with a durable insulation such as Teflon. The umbilical connector 31 allows said umbilical to be disconnected for ease of adjustments, maintenance and repair.

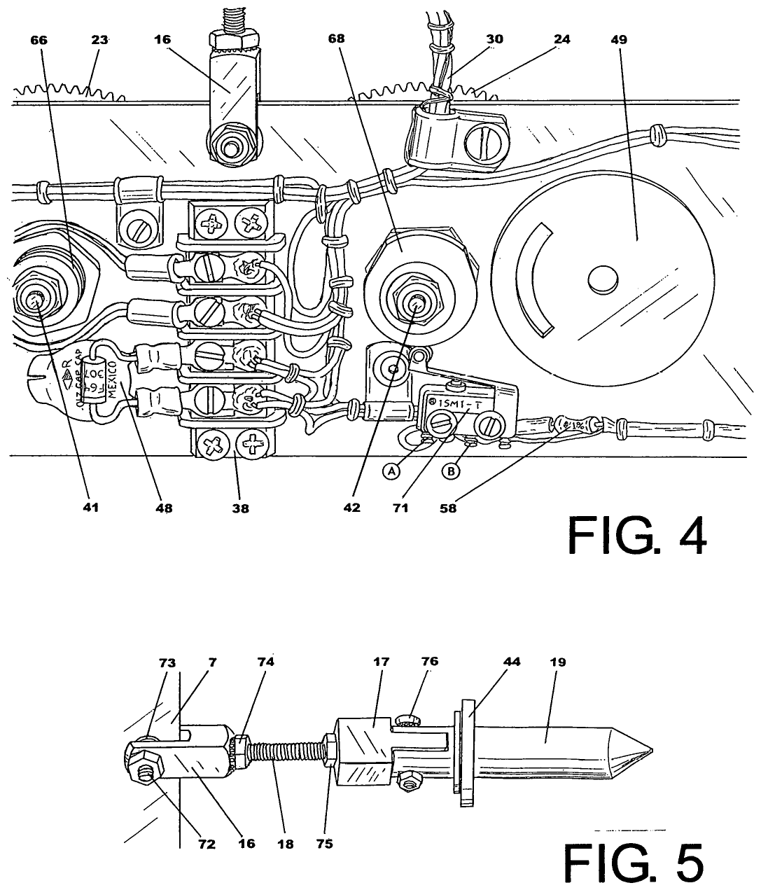

The power and signal distribution block 32 (lower mid-right) is a convenient connection and testing access point. The solenoid termination feed-thru block cover plate 33 allows power to be safely fed through the thrust plate 2 to the solenoid 4 shifter(s). The connector jack 34 (lower mid-right) safely feeds power through the thrust plate from outside the apparatus. A DC to DC power conversion circuit board 35 (near-by) allows for one voltage source from an external power supply to provide the two different voltages required to power the apparatus: an adjustable DC voltage to motor 20 to drive the rotors, and a fixed DC voltage to power solenoid 4 shifter(s). LED 36 (upper center on carriage 7) lights when the shifter(s) is disengaged and is not imperative to operation but may be useful to verify cycle time. Switch 37 (lower center on carriage 7) disengages the solenoid 4 shifter(s) for ease of troubleshooting and maintenance. Terminal block 38 (left of center on carriage 7) mounts on the reverse side of said carriage 7 which routes and connects the wiring on the back of the carriage plate 7 and will be reviewed in FIG. 2 and FIG. 4. The various fasteners are solenoid mounting nut 39 (far right center) which fastens the solenoid 4 shifter(s) to thrust plate 2. Idler gear bolt, pin or shaft 40 (lower center) secures idler gear 22. First rotor gear bolt, pin or shaft 41 secures driver gear 23. Second rotor gear bolt, pin or shaft 42 secures driver gear 24. Components 43 (shown throughout) are clamps, nut and bolts, spacers and other such fasteners and hardware. Such mounting screws secure the glide rod linear bushing housings shown in FIG. 2, the motor and other support components onto the carriage plate 7. A silicone or other energy absorbing washer 44 (far right center) cushions the impact of the plunger 19 when it engages the shifter solenoid 4.

Referring to FIG. 2, Switch 45 on the carriage plate 7 disengages the motor that drives the rotors for ease of troubleshooting, along with 37 which disengages the shifter 4. Terminal feed-thru block 46 (far left below center) allows for the connection of the solenoid and snubber 47 and also serves as test points. Snubber 47 connects parallel to, or in series with, solenoid 4 to minimize back electromagnetic force (EMF) to the rest of the electronics when the solenoid is disengaged during each cycle. Another arc suppression device of design, components 48 (near carriage center) comprising of spark-gap capacitor or gas discharge device in electrical parallel with a fast recovery blocking diode in the nano-second range, protects the digital optic commutator circuit board 50 (top center on carriage 7). The digital optic commutator 50 triggers the solenoid at a predetermined time of the cycle when optic cam 49 allows (or interrupts) the infrared (IR) beam in the sensor 51 (mounted on circuit board 50).

Other components are the glide rod feet pads 52 (far right), the glide rod linear bushing housings 56 (top and bottom center on carriage 7), the cycle indicator LED 57 for the commutator circuit board 50, current limit resistor 58 (just to the right for cycle LED 36), and the feed-through grommet 59 (upper left on carriage 7) supplying an electrical link to the current limit resistor 29.

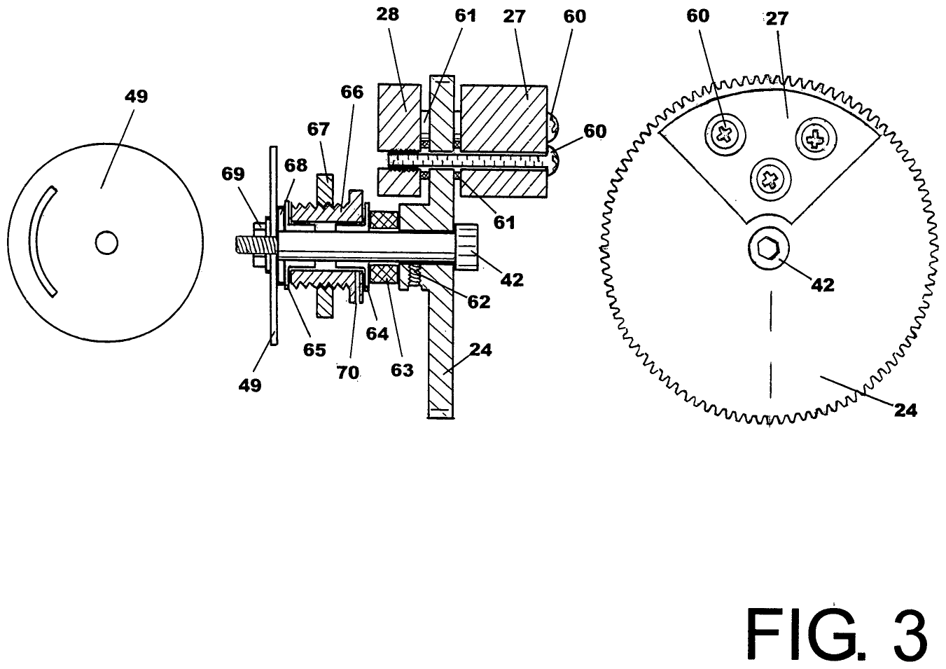

Negative phase dampening is achieved by employing an impact absorbing material such as Sorbothane, polyurethane, silicone or other similar material 55 (top and bottom far right) with a “low shape factor” and low durometer, formed as thick washers or pads. These pads may also be toroidal-shaped and gas-filled. Said pad may be stacked and separated with tack-barrier washers such as Mylar or other suitable material 54. A stack of multiple pads of such material will absorb and deflect energy better than a contiguous rod or tube, though such a method may also be employed. Compression washers 53 evenly disperse the negative swing energy into the pads 55. This energy absorbing stack is mounted directly in line with the carriage behind the rear springs 11 onto the glide rods or rails 8. The stack may be coated with a dry lubricant such a molybdenum disulfide, graphite or powered Teflon (PTFE) or other such lubricant to prevent galling and sticking to the glide rods or rails. This stack significantly nulls the back-swing of the carriage 7 deflecting the applied force 90 degrees by bulging the low durometer pads 55. Machine parts 66, 67, 69 and 70 are discussed in FIG. 3. Microswitch 71 is discussed in FIG. 4 and fasteners 72 and 76 are discussed in FIG. 5. Other reference characters in FIG. 2 were mentioned in FIG. 1.

FIG. 3 depicts a cut-a-way view of the rotor assembly of the apparatus wherein gear 24 illustrated here with its rotor stack 27 and 28 held together with fasteners 60 secured by threads in 28 though gear 24. The rotor segments 27 and 28 are separated from gear 24 with spacers 61 to isolate the rotors from the lubrication on the gear teeth and to help reduce air resistance when the invention is used within an atmospheric environment. Gear 24 is fastened with set screw 62 to shoulder bolt axle 42 or other such shaft, which journals through spacer 63, which allows space for rotor segment 28, and through bushings 64 and 65. Axle 42 also journals through bulkhead journal fitting 67 through mechanical timing cam 68 and optic cam 49 and secured with nut 69 which provides the position needed to fire the shifter(s) at the appropriate time. An oil port 70 is provided in bulkhead fitting 67.

FIG. 4 is an enlarged view of the electrical and timing circuitry of the carriage detailing an emergency back-up analog cam system in case of an EMP attack upon the apparatus. Bulkhead journal fitting 66 secures gear 23 by housing axle 41. The rotary cam 68 mounts directly under optic cam 49 (also in FIG. 2) shown off to the side here, on the same axis 42 with the high current roller-actuated micro-switch 71 (also in FIG. 2) so as to actuate the shifter(s) at the proper time in the cycle. Said micro-switch is arc-protected with the same high-current suppressor 48 used with the electronic cam circuit 50. Said suppressor 48 is EMP resistant by virtue of the fast recovery diode's high current rating and the gap-cap capacitor which discharges over-voltage limits. A neon lamp, a similar threshold discharge device, or other arc suppression device may also be employed across the contacts of 48 for added protection against EMP attack and switch contact wear from arcing. One side of terminal block 38 is used as a series of solder connection “pots” wherein terminal lugs are eliminated for a more efficient and secure electrical connection.

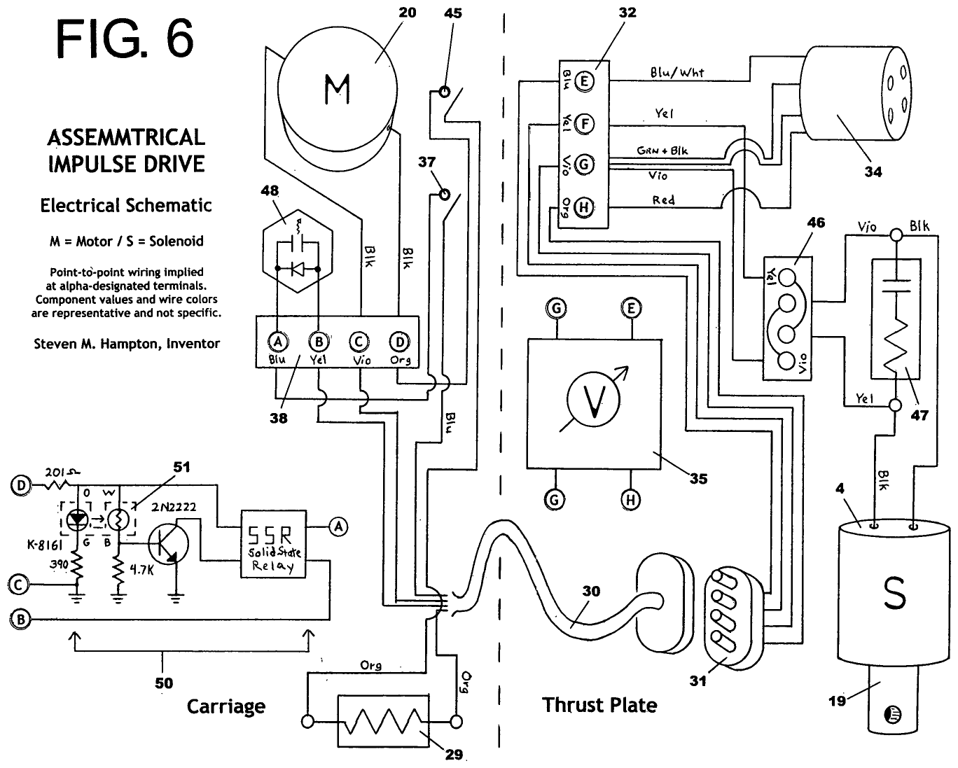

Terminal points A and B in FIG. 4 are auxiliary connections to terminal points A and B displayed and discussed in FIG. 6 below. Other reference characters in FIG. 3 were mentioned in FIG. 1 and FIG. 2.

FIG. 5 shows the adjustable linkage between the carriage plate 7 and the solenoid plunger 19 with its energy absorbing washer 44. Said linkage determines the precise stroke length of the carriage system and allows for slight variations to plunger alignment during operation to reduce possible wear of the solenoid sleeve. Said linkage and the glide rod spacers 10 set the mean distance required to gain maximum thrust from the apparatus. Clevis 16 straddles the carriage plate 7 through a hole that is secured with a fastener 72. The clevis 16 has a wide enough gap in its flanges to allow for fine-tuning its position on the carriage plate 7 with shim washers 73 so as to align the plunger 19 within the cavity of the solenoid 4. A long set screw 18 travels though the clevis threaded hole and binds to the top edge of carriage plate 7. Said long set screw 18 is secured with locking nut 74 and seats onto the front surface of clevis 16 to facilitate a positive juncture for the solenoid plunger 19. The head of set screw 18 is threaded into plunger tongue adapter 17. This arrangement allows for the secure attachment of the linkage after locking nut 75 is turned down to secure the tongue adapter 17 to the plunger 19 with fastener 76. Here should be noted that even if perfect plunger-to-solenoid alignment is achieved, a non-magnetic dry lubricant upon the plunger may be employed to minimize wear from long time use.

FIG. 6 is an electrical block schematic of the apparatus. Primary power is provided through connector 34 (upper right). The DC to DC converter 35 (center) is a variable power supply that allows for one primary fixed voltage source to be divided into a second source to power the rotors, wherein the voltage can be adjusted to vary the speed of the machine and may be mounted either on the apparatus or near the primary power source. Terminal point A (lower left) is the output of the digital optic commutator circuit board 50 (lower left) and routes to terminal block 38, and with terminal point B also on terminal block 38 and the action of the optic/analog cam 49/68 acts as a series switch to turn on solenoid 4 (shown with its plunger 19, lower right) when sensor 51 is activated by optic cam 49 (in FIG. 2). Power for solenoid 4 is supplied by feed-through terminal block 46 (right center) through thrust plate 2 (FIG. 1 and FIG. 2). Said terminal points A and B are also connected to terminal points A and B on switch 71 in FIG. 4. Terminal C connects to terminal block 38 for a return circuit of the power source supplied at terminal D also on terminal block 38 for the electric motor 20 (upper left) that drives the rotors.

The DC to DC power conversion circuit board 35 takes the solenoid DC voltage (which is the highest voltage in the system) from terminal points E and G on terminal block 32 to step it down to a lower DC voltage to operate the motor 20 for proper rotor acceleration. This lower voltage output from converter 35 is routed back to terminal points G and H on terminal block 32 and thus to the motor 20 through umbilical connector 31 and the umbilical itself 30 (lower center) then through optional current limit resistor 29 and switch 45. Terminal G is common ground for both the motor and DC to DC converter which is electrically common with terminal C on terminal block 38. Terminal H on terminal block 32 routes to terminal D on terminal block 38 also through umbilical 30 for a controlled motor voltage. Terminal F on terminal block 32 electrically connects through umbilical 30 and switch 37 to terminal B on terminal block 38 and supplies the higher fixed DC voltage for the solenoid 4. Components arc-suppressor 48 is mounted electrically across terminals A and B on terminal block 38, and back EMF snubber 47 (far right center) is electrically across solenoid 4

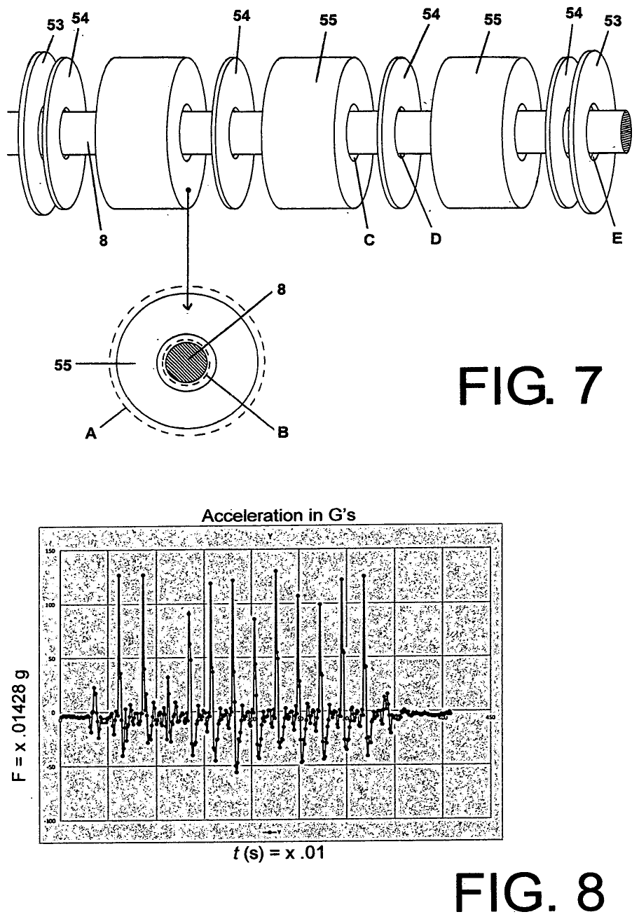

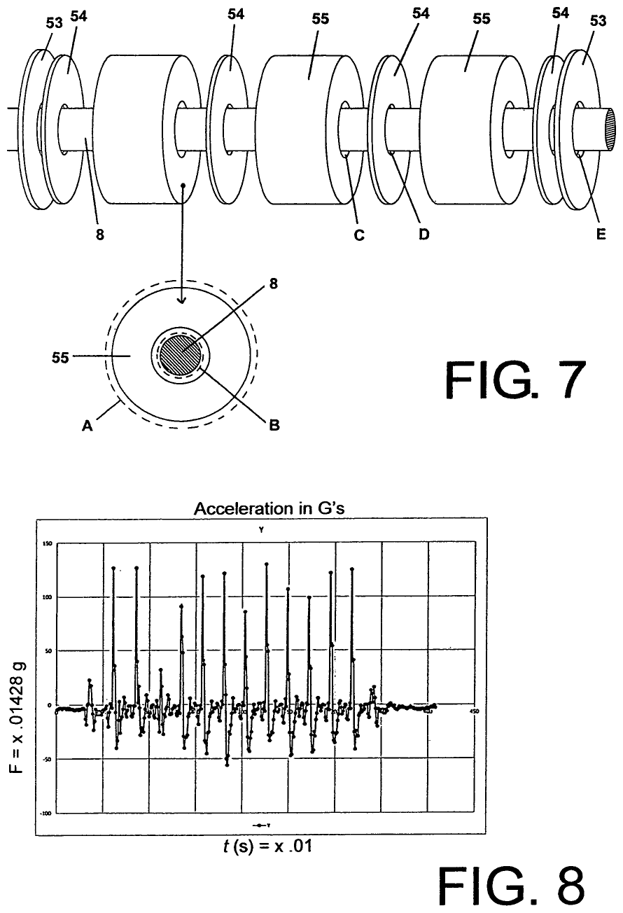

FIG. 7 is a detail of the negative phase dampener. Glide rod 8 journals through compression washers 53, tack barrier washers 54 and low Durometer pads 55. Mechanical considerations are A: Pad Deflection outside diameter, B: Pad Deflection maximum inside diameter, C: Pad inside diameter must clear 8 during action at B, D: Tack Barrier Washer inside diameter must freely clear glide rod 8 but less than C during action at B, E: Compression Washer inside diameter must not rub glide rod 8.

FIG. 8 is a digital accelerometer test chart. In this test the invention was hanging from a free-swinging 4-line pendulum with the accelerometer mounted on the apparatus and at approximately 3.7 Hz is producing 1.69 g average thrust without ejecting mass. The swinging back of the apparatus under the force of gravity between pulses accounts for the negative spikes. Chart is not zero-adjusted so baseline reads −5 increments (add 5 to positive peaks).

I claim:

1. A freely suspended flat plate or tray for use in association with converting rotary motion into linear motion using a dynamic system producing unidirectional movement, comprising;
attached gears with respective eccentric masses
attached electric motor or motors;
attached wiring and associated components;
attached linear bearing housings and bushings to contain glide rods for suspension;
attached timing cams and sensors;
attached adjustable linkage to shift said freely suspended flat plate or tray.

2. A freely suspended flat plate or tray as described in claim 1 for use in association with converting rotary motion into linear motion using a dynamic system producing unidirectional movement, for spinning a plurality of gears and eccentric masses;
with eccentric masses mounted directly onto one or both faces of the rotor gears;
with said rotor gears driven by a compact torque-increasing gear train powered by an electric motor.

3. A freely suspended flat plate or tray as described in claims 1 and 2, for use in association with converting rotary motion into linear motion using a dynamic system producing unidirectional movement, wherein said freely suspended flat plate or tray is suspended on compression spring-surrounded glide rods.

4. A freely suspended flat plate or tray as described in claim 3, for use in association with converting rotary motion into linear motion using a dynamic system producing unidirectional movement, wherein said freely suspended flat plate or tray is suspended on compression spring-surrounded glide rods with bushings on both ends of each spring for low friction and isolation from the glide rods from said compression springs in the plane of oscillation.

5. A freely suspended flat plate or tray as described in claims 1, 3, and 4 for use in association with converting rotary motion into linear motion using a dynamic system producing unidirectional movement, wherein a means for cancelling the negative force of the freely suspended flat plate or tray cycle by;
diverting the negative force to right angles of said applied negative force by gas compression;
diverting the negative force to right angles of the applied negative force with energy-deflecting pads;
consuming the negative force with energy-absorbing pads.

6. A freely suspended flat plate or tray as described in claim 1 for use in association with converting rotary motion into linear motion using a dynamic system producing unidirectional movement, wherein a means for providing an adjustable solenoid shifter linkage mechanism from the freely suspended flat plate or tray to said solenoid plunger using a clevis and adjustable plunger adaptor tongue.

7. Based on the apparatus using a freely suspended flat plate or tray for converting rotary motion into linear motion as described in claims 1 and 6 for use in association with converting rotary motion to linear motion using a dynamic system producing unidirectional movement, wherein the apparatus solenoid shifter is controlled by utilizing a transparent film disc or cam with a painted, printed or perforated arc on or within the disc, controlled by the whirling eccentric masses and interfacing with or intersecting with;
roller actuated electric switch;
optical-electronic sensor or encoder device.

8. Based on the apparatus using a freely suspended flat plate or tray for converting rotary motion into linear motion as described in claims 1, 2, 3, 4, 5 and 6 for use in association with converting rotary motion to linear motion using a dynamic system producing unidirectional movement, wherein a means is provided to hold the apparatus mainframe together;
with supporting stanchion rods using clamps;
with supporting stanchions using threaded rods and nuts.

9. Based on the apparatus using a freely suspended flat plate or tray for converting rotary motion into linear motion as described in claims 1, 2, 3, 4, 5, 6, 7 and 8, for use in association with converting rotary motion into linear motion using a dynamic system producing unidirectional movement, wherein two or more said freely suspended flat plates or trays may be employed in the apparatus mainframe for the smooth generation of thrust.
